(19) United States
(12) Patent Application Publication
(10) Pub. No.: US 2014/0380020 A1
(43) Pub. Date: Dec. 25, 2014

(54) SYSTEM AND METHODS FOR SYNCHRONIZATION OF REDUNDANT PROCESSING ELEMENTS

(71) Applicant: Honeywell International Inc., Morristown, NJ (US)

(72) Inventors: Scott Gray, Peoria, AZ (US); Nicholas Wilt, Glendale, AZ (US)

(21) Appl. No.: 13/925,004

(22) Filed: Jun. 24, 2013

(51) Int. Cl. G06F 9/38

(52) U.S. Cl. CPC G06F 9/3877
USPC 712/203

(57) ABSTRACT

System and methods for synchronizing redundant processing elements are provided. In certain embodiments, a self-checking pair of system on chips (SoCs) includes a first SoC configured to execute a first plurality of instructions; and a second SoC configured to execute a second plurality of instructions that are approximately identical; wherein the first SoC exchanges a first instruction count with the second SoC, the first instruction count identifying a number of instructions executed by the first SoC; wherein the second SoC exchanges a second instruction count with the first SoC, the second instruction count identifying a number of instructions executed by the second SoC; and wherein the first SoC executes a first single step execution utility to synchronize the first instruction count with the second instruction count and the second SoC executes a second single step execution utility to synchronize the first instruction count with the second instruction count.

### BACKGROUND

In certain modern commercial off the shelf (COTS) system on chip (SoC) processing solutions in a self-checking pair (SCP) processing environment, the internal resources of the chips are not synchronous with each other and run in different clock domains. The internal design allows for many configurations of the processing cores vs. the speed of the provided peripherals to match a customer's requirements. However, the internal design also means that using two of the SoCs in a SCP processing environment presents difficulties in keeping the two lanes synchronized as the processors are guaranteed to “skew” with respect to each other.

Difficulty arises when the two SoCs need to communicate off chip since the two chips are essentially asynchronous in relation to one another. This also means that using all the resources provided within the chip that communicate off-chip (i.e. Ethernet, RS-232, USB) are generally unavailable for an SCP processing architecture since the other lane cannot see those resources in both lanes. Another issue of using COTS SoC processing solutions arises when the processors need to respond to interrupts such as internal timers, packet buffer flags, or external resources such as a frame time interrupt. There will generally always be some skew between the lanes such that the processors do not take the interrupt at the exact same instruction.

Further, the refreshes to the random access memory (RAM) connected to the SOCs are not synchronized between lanes when using the internal controllers to do the refreshes, so that one lane may need to wait for a refresh of the memory to complete while the other lane gets data just prior to the refresh which may cause a skew of hundreds of instructions between lanes for each such event.

### SUMMARY

System and methods for synchronizing redundant processing elements are provided. In certain embodiments, a self-checking pair of system on chips includes a first system on chip configured to execute a first plurality of instructions; and a second system on chip configured to execute a second plurality of instructions, wherein the second plurality of instructions and the first plurality of instructions are approximately identical; wherein the first system on chip exchanges a first instruction count with the second system on chip, the first instruction count identifying a number of instructions executed by the first system on chip; wherein the second system on chip exchanges a second instruction count with the first system on chip, the second instruction count identifying a number of instructions executed by the second system on chip; and wherein the first system on chip executes a first single step execution utility to synchronize the first instruction count with the second instruction count and the second system on chip executes a second single step execution utility to synchronize the first instruction count with the second instruction count.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of two system on chips arranged in a self checking pair in one embodiment described in the present disclosure;

FIG. 2 is an execution timeline illustrating the synchronization of application instruction execution by two system on chips in a self checking pair arrangement in one embodiment described in the present disclosure; and

FIG. 3 is a flow diagram of a method for synchronizing system on chips in one embodiment described in the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments for synchronizing two different system on chips (SoCs) are provided herein. When two different SoCs operate in different clock domains, the execution of instructions on the different SoCs can be interrupted. When the execution of instructions on the different SoCs is interrupted, each SoC identifies the current instruction number that is being executed and this instruction number is communicated to the other SoC. Each SoC then compares its current instruction number against the received instruction number from the other SoC. If the current instruction number is ahead of the received instruction number, the SoC remains idle and waits for the other SoC to reach the current instruction number. If the current instruction number is behind the received instruction number, a single step execution utility on the SoC steps through the instructions until the current instruction number is equal to the received instruction number. When the current instruction number equals the received instruction number, both SoCs recommence execution.

The different SoCs are synchronized with one another to eliminate skew, or the difference in instruction number between the different SoCs. In certain implementations, to prevent refreshing of DRAM from increasing the skew such that unreasonable amounts of time may be needed to resynchronize the different SoCs, the DRAM is refreshed at the same time.

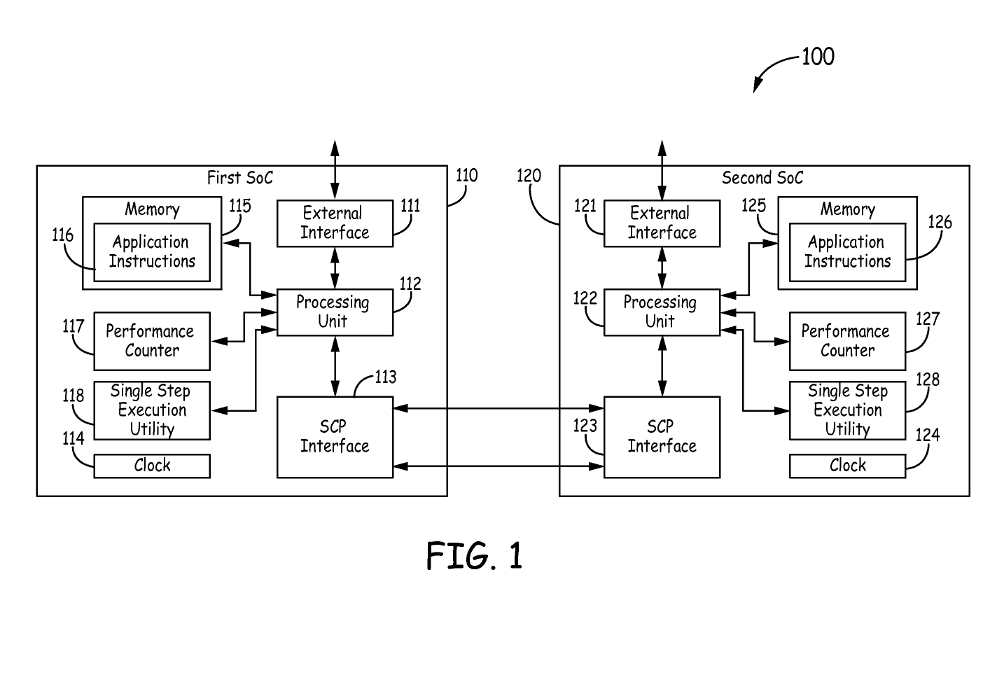

FIG. 1 is a block diagram of a first SoC 110 and a second SoC 120 that form a self checking pair 100. Both the first SoC 110 and the second SoC 120 are systems that are integrated on a single respective die. The first SoC 110 includes a processing unit 112 that executes application instructions 116 stored in memory 115. Similarly, the second SoC 120 includes a processing unit 122 that executes application instructions 126 stored in memory 125. In certain implementations, the processing units 112 and 122 may each include multiple processors that synchronously operate. Further, the first SoC 110 and the second SoC 120 may be implemented using a field programmable gate array (FPGA), an application-specific integrated circuit (ASIC), a custom designed ASIC, or the like. Also, the processing units 112 and 122 may include any suitable processing device such as a digital signal processor (DSP), central processing unit (CPU), micro-controller, or arithmetic logic unit. The memories 115 and 125 may also comprise any suitable storage entity such as a flash drive, magnetic-disk drive, RAM (e.g., DRAM), ROM, PROM, or CD/DVD/Blu-ray, optical storage or optoelectronics circuits.

Further, first SoC 110 and the second SoC 120 are functionally identical, that is the processing unit 112 on the first SoC 110 and the processing unit 122 on the second SoC 120 execute the same computer readable instructions.

In other implementations, two functionally identical SoCs are synchronized by receiving the same clock signal. However, as illustrated, the first SoC 110 includes a clock 114 and the second SoC 120 includes a clock 124. Because the first SoC 110 has a clock 114 that operates independently from the clock 124 in the second SoC 120, the first SoC 110 operates in a different clock domain from the second SoC 120. Because the first SoC 110 and the second SoC 120 operate in different clock domains, the processing unit 112 on the first SoC 110 and the processing unit 122 on the second SoC 120 may respectively execute application instructions 116 and 126 at different rates. When the processing unit 112 executes application instructions 116 at a different rate than the processing unit 122 executes application instructions 126, one of the processing units may execute more instructions in a period of time. The execution of different numbers of instructions in a period of time may cause the processing units 112 and 122 to skew away from one another and execute different instructions at the same time.

In certain implementations, to correct the skew that arises between processing units 112 and 122 when the processing units operate in different clock domains, the SoCs 110 and 120 respectively include performance counters 117 and 127 and single step execution utilities 118 and 128. In certain implementations, the performance counter 117 is a register that stores an instruction count, wherein the instruction count is the number of instructions that have been executed by a processor. For example, when the processing unit 112 in the SoC 110 receives an instruction to execute from application instructions 116, the performance counter 117 is incremented to represent the number of executed instructions. Further, the instruction count stored in the performance counter 117 identifies instructions at various levels of abstraction from machine language. For example, the instruction count may count instructions that execute in an assembly language. Also, the instruction count may also count instructions that execute in a java script. The instruction count identifies instructions at a level that permits synchronization of the first SoC 110 and the second SoC 120. The performance counter 127 functions similarly to the performance counter 117. In at least one embodiment, the single step execution utility 118 can be controlled to single step through individual instructions when the execution of application instructions 116 is paused. The single step execution utility 128 functions in a similar manner.

Further, in at least one embodiment, the first SoC 110 communicates with other external systems through an external interface 111. For example, the external interface 111 may enable communication with external systems through a PCIe, Spacewire, Ethernet, a dedicated bus, RS-232, RS-485, MIL-STD 1553, and the like. Likewise, the second SoC 120 includes an external interface 121 that functions similarly to the external interface 111. In a further implementation the first SoC 110 includes an SCP interface 113. The first SoC 110 communicates with the second SoC 120 through the SCP interface 113 on the first SoC 110. When the first SoC 110 transmits data to the second SoC 120, the data is sent to the second SoC 120 through the SCP interface 113. The second SoC 120 then receives the data through an SCP interface 123 on the second SoC 120. Likewise, when, the second SoC 120 transmits data to the first SoC 110, the data is sent to the first SoC 110 through the SCP interface 123. The first SoC 110 then receives the data through the SCP interface 113 on the first SoC 110. In certain implementations, the external interface 111 functions as the SCP interface 113. Likewise, the external interface 121 functions as the SCP interface 123.

To correct the skew that occurs due to the different clock domains, the first SoC 110 and the second SoC 120 periodically pause the execution of application instructions 116 and 126 by the respective processing units 112 and 122. When the execution of the application instructions 116 and 126 is paused, the first SoC 110 communicates the instruction count that is presently stored in the performance counter 117 to the second SoC 120 through the SCP interface 113. Likewise, the second SoC 120 communicates the instruction count that is presently stored in the performance counter 127 to the first SoC 110 through the SCP interface 123. When the first SoC 110 receives the instruction count value that was stored in the performance counter 127 from the second SoC 120, the processing unit 112 compares the instruction count in performance counter 117 with the received instruction count that was stored in performance counter 127.

When the instruction count stored in the performance counter 117 on the first SoC 110 is less than the instruction count stored in the performance counter 127 on the second SoC 120, the single step execution utility 118 steps through application instructions 116 until the instruction count stored in the performance counter 117 is equal to the instruction count received from the second SoC 120 that represents the instruction count stored in the performance counter 127. When the instruction count in the performance counters 117 and 127 are equal, the first SoC 110 may send a signal to the second SoC 120 indicating that the performance counters are equal. Whereupon, the second SoC 120, which remains idle when the single step execution utility 118 operates on the first SoC 110, recommences execution of the application instructions 126 on the processing unit 122.

When the instruction count stored in the performance counter 117 on the first SoC 110 is greater than the instruction count stored in the performance counter 127 on the second SoC 120, the debug utility 128 steps through application instructions 126 until the instruction count stored in the performance counter 127 is equal to the instruction count received from the first SoC 110 that represents the instruction count stored in the performance counter 117. When the instruction counts stored in the performance counters 117 and 127 are equal, the first SoC 120 may send a signal to the first SoC 110 indicating that the instruction counts are equal. Whereupon, the first SoC 110, which remains idle when the single step execution utility 128 operates on the second SoC 120, recommences execution of the application instructions 116 on the processing unit 112.

In at least one embodiments, when the single step execution utility 118 steps through application instructions 116, the first SoC 110 sends the instruction count in the performance counter 117 to the second SoC 120 during each change in the performance counter 117. In a further implementation, the performance counter 117 and 127 function as registers on the first SoC 110 and the second SoC 120 that are readable by external systems.

As stated above, the synchronization of the execution of the application instructions 116 and 126 may be performed periodically. Also, the synchronization of the execution of the application instructions 116 and 126 may be performed at variable time intervals. Alternatively, the synchronization may be performed whenever a processing unit 112 and 122 performs a context switch between different executing applications. Further, the synchronization may be performed as directed in the application instructions 116 and 126. In at least one exemplary implementation, the synchronization of the execution of the application instructions 116 and 126 may be performed periodically, upon context switching, and/or as directed by the application instructions 116 and 126.

In certain embodiments, where memory 115 and memory 125 include synchronous dynamic random-access memory (SDRAM), such that the memory requires refreshing in order to maintain the integrity of the data, the refreshing of memory may potentially increase the skew such that synchronizing the performance counters 117 and 127 with one another may take an undue amount of time. As mentioned above, refreshes to SDRAM connected to the SoCs are not synchronized to the same clock domain. As such, an SoC operating in one clock domain waits for a refresh of the memory to complete while the SoC operating in a different clock domain acquires data just prior to the refresh. This difference between clock domains may cause many instructions to be executed in the clock domain that was not delayed for each such event that occurs.

In at least one implementation, the skew comes about because, to preserve the integrity of data, SDRAM is refreshed periodically according to a refresh cycle. Refresh cycles, if automatically generated by a built-in SDRAM Controller, occur asynchronously to the execution of application instructions 116. As the performance counters 117 and 127, associated with the instructions that are currently executing on processing unit 112 and processing unit 122, may store instruction counts that are slightly different from one another, one access to SDRAM in a first SoC 110 could be concurrent with the refresh cycle request and thus be delayed by the refresh period for the SDRAM while the second SoC 120 may acquire the data from the SDRAM one clock cycle before the start of the refresh cycle. The difference in accessing data in the SDRAM in the different clock domains may increase the skew as the non-delayed SoC (in this example, the second SoC 120) will continue to execute instructions while the other SoC (in this example, the first SoC 110) is refreshing the SDRAM. Statistically, the increase of skew due to the refreshing of SDRAM may happen multiple times during the execution of an application.

In certain embodiments, to prevent large skews between processor execution due to the refresh of SDRAMs, the SDRAM refresh cycles are generated by software. When the refresh cycles are generated by software, multiple refresh cycles can be performed at a time. For example, up to eight refreshes cycles can be performed and then eight refresh intervals can be skipped. When the last refresh cycle is being performed, the processing units 112 or 122 synchronize the execution in the different clock domains. In at least one exemplary implementation, the code that generates the SDRAM refreshes is frequently executed. Thus, the refresh generation code may be locked in at least an L3 cache (the refresh generation code may also be stored in an L1 or L2 cache). By locking the refresh generation code in the cache, the throughput impact is lessened and the code is accessible during a refresh. Further, code that controls the single step execution utilities 118 and 128 also may be locked in at least an L3 cache. By controlling the refresh cycles through software, skew that results from refreshing of the SDRAM is inhibited. As the skew from refreshing is inhibited, there are fewer instructions to be stepped through by either of the single step execution utilities 118 and 128 when synchronizing the execution of the application instructions 116 and 126.

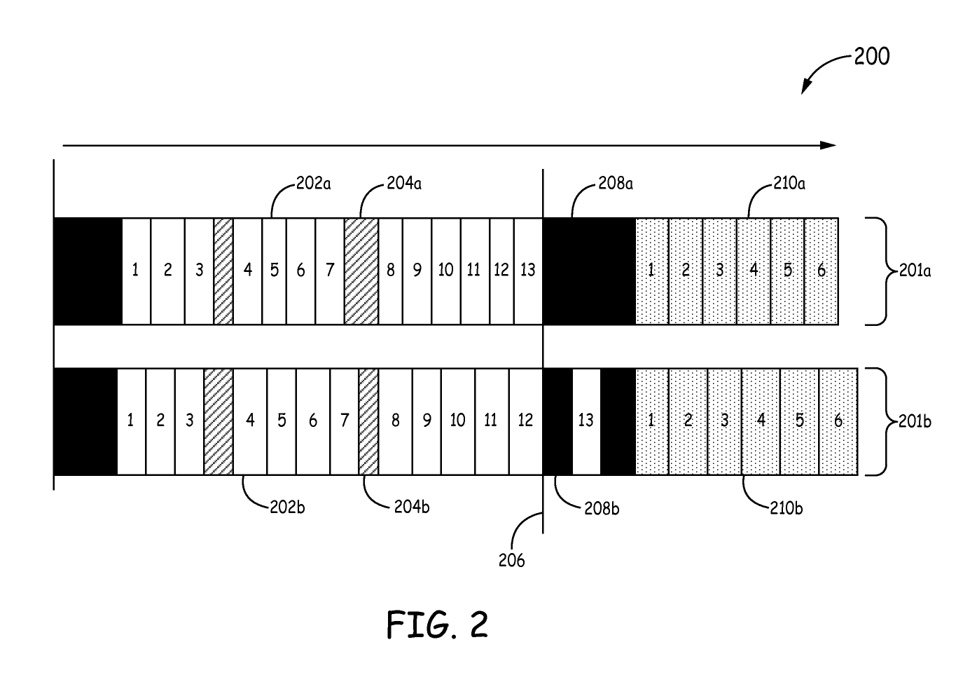

FIG. 2 is a timeline 200 illustrating the execution of instructions from applications on different processing units, where each processing unit is on a different SoC and the SoCs function together in a SCP arrangement. For example, a first SoC 201a executes a first application 202a and a second application 210a. Likewise a second SoC 201b executes the first application 202b and the second application 210b. As can be seen from the figure, both the first SoC 201a and the second SoC 201b execute a respective first application 202a and 202b until a context switch interrupt 206, where the context switch interrupt 206 initiates context switch time 208a and 208b. After the context switch, both the first SoC 201a and the second SoC 201b execute a respective second application 210a and 210b. However, before the context switch interrupt 206, whereas the first SoC 201a was able to execute 13 instructions of the first application 202a, the second SoC 201b was able to execute 12 instructions of the first application 202b. To synchronize the execution of applications by the first SoC 201a and the second SoC 201b, during the context switch 208a and 208b, the second SoC 201b starts a single step execution utility that steps through the instructions until both of the first SoC 201a and the second SoC 201b have executed the same number of instructions. For example, the single step execution utility on the second SoC 201b executes the 13th instruction of the first application 202b. After the single step execution utility executes the 13th instruction, both the first SoC 201b and the second SoC 201a execute the second application 210a and 210b.

In certain implementations, an SoC may receive input/output (I/O) accesses during the execution of an application. For example, the first SoC 201a receives I/O accesses 204a during the execution of the first application 202a and the second SoC 201b receives I/O accesses 204b during the execution of the second application 202b. To prevent the I/O accesses from increasing the skew between the first SoC 201a and the second SoC 201b, both the first SoC 201a and the second SoC 201b wait until both of I/O accesses 204a and 204b are complete before recommencing execution of the respective first application 202a and 202b. Thus, as both the first SoC 201a and the second SoC 201b wait for the completion of the I/O accesses 204a and 204b, the I/O accesses 204a and 204b may not contribute to the skew between the first SoC 201a and the second SoC 201b.

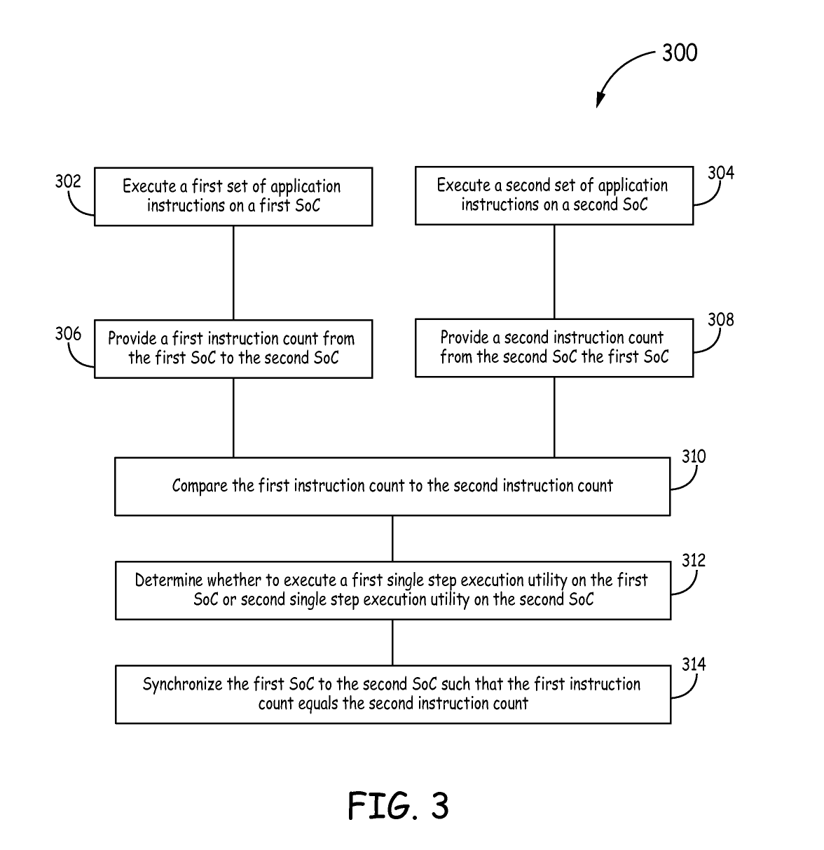

FIG. 3 is a flow diagram of a method 300 for synchronizing the execution of two SoCs in an SCP arrangement. Method 300 proceeds at 302, where a first set of application instructions are executed on a first system on chip. Method 300 proceeds at 304, where a second set of application instructions are executed on a second system on chip. When the first SoC and the second SoC are in an SCP arrangement, the first set of application instructions and the second set of application instructions may be approximately identical, wherein instructions are approximately identical when they are interpreted as possessing the same information by both the first SoC and the second SoC.

Further, method 300 proceeds at 306, where a first identification value is provided from the first SoC to the second SoC. Also method 300 proceeds at 308, where a second identification value is provided from the second SoC to the first SoC. For example, the first SoC and the second SoC each store an instruction count that identifies the number of instruction respectively executed by the first SoC and the second SoC. Periodically, the first SoC and the second SoC provide their instruction count to the other SoC in the SCP. When the instruction count values are exchanged, the method 300 proceeds at 310 where the first instruction count is compared to the second instruction count. For example, each SoC compares the first instruction count to the second instruction count to determine whether the first SoC is behind the second SoC in processing application instructions or the second SoC is behind the first SoC in processing application instructions.

In at least one implementation, the method 300 proceeds at 312, where it is determined whether to execute a first single step execution utility on the first SoC or a second single step execution utility on the second SoC. For example, when the first SoC is behind the second SoC in processing application instructions, as determined by comparing the first and second instruction count, the first SoC will execute an associated single step execution utility. In contrast, when the second SoC is behind the first SoC in processing application instructions, as determined by comparing the first and second instruction count, the second SoC will executes an associated single step execution utility. The method 300 then proceeds at 314, where the first SoC is synchronized to the second SoC such that the first instruction count equals the second instruction count. In at least one exemplary implementation, when the first single step execution utility is executed, the first single step execution utility incrementally steps through the application instructions until the first instruction count equals the second instruction count. Conversely, when the second single step execution utility is executed, the second single step execution utility incrementally steps through the application instructions until the second instruction count equals the first instruction count. When the first instruction count is equal to the second instruction count, the execution of application instructions by the first SoC is synchronized with the execution of application instructions by the second SoC. In at least one implementation, the synchronization of the first SoC with the second SoC is performed periodically, at variable time intervals, or at context switches between executing applications.

### EXAMPLE EMBODIMENTS

Example 1 includes a method for using a system on chip, the method comprising: storing a plurality of instructions, single step execution utility instructions, and a performance counter, wherein the performance counter stores a first instruction count, wherein the first instruction count identifies the number of instructions executed by the system on chip; executing the plurality of instructions; communicating with external systems through the at least one communication interface; receiving a second instruction count from a second system on chip through a communication interface of the at least one communication interface; comparing the second instruction count to the first instruction count; and executing the single step execution utility instructions to synchronize the second instruction count with the first instruction count based on the comparison of the second instruction count to the first instruction count.

Example 2 includes the method of Example 1, wherein comparing the second instruction count to the first instruction count determines at least one of: whether the second instruction count is behind the first instruction count; whether the first instruction count is behind the second instruction count; and whether the first instruction count equals the second instruction count.

Example 3 includes the method of any of Examples 1-2, wherein executing the single step execution utility instructions comprises at least one of: stepping through individual instructions in the plurality of instructions until the first instruction count equals the second instruction count; and pausing execution of the plurality of application instructions until the first instruction count equals the second identification value.

Example 4 includes the method of any of Examples 1-3, wherein the second instruction count is compared to the first instruction count at at least one of: a context switch between execution of different applications; and at the end of a variable time interval; at the end of a periodic time interval.

Example 5 includes the method of any of Examples 1-4, further comprising refreshing at least one dynamic memory unit as directed by at least one instruction in the plurality of instructions.

Example 6 includes the method of any of Examples 1-5, further comprising: pausing execution of the plurality of instructions upon the reception of an input/output access; recommencing execution of the plurality of instructions upon the completion of the input/output access on both the system on chip and the second system on chip.

Example 7 includes the method of any of Examples 1-6, wherein the system on chip and the second system on chip operate in different clock domains.

Example 8 includes the method of any of Examples 1-7, wherein the performance counter is a register that is readable by an external system.

Example 9 includes a self-checking pair of system on chips, the self-checking pair comprising: a first system on chip configured to execute a first plurality of instructions; a second system on chip configured to execute a second plurality of instructions, wherein the second plurality of instructions and the first plurality of instructions are approximately identical; wherein the first system on chip exchanges a first instruction count with the second system on chip, the first instruction count identifying a number of instructions executed by the first system on chip; wherein the second system on chip exchanges a second instruction count with the first system on chip, the second instruction count identifying a number of instructions executed by the second system on chip; wherein the first system on chip executes a first single step execution utility to synchronize the first instruction count with the second instruction count and the second system on chip executes a second single step execution utility to synchronize the first instruction count with the second instruction count.

Example 10 includes the self-checking pair of Example 9, wherein the first system on chip compares the first instruction count against the second instruction count to determine whether to execute the first single step execution utility; and the second system on chip compares the first instruction count against the second instruction count to determine whether to execute the second single step execution utility.

Example 11 includes the self-checking pair of Example 10, wherein each of the first system on chip and the second system on chip are configured to compare the first instruction count to the second instruction count to determine at least one of whether the second instruction count is less than the first instruction count; whether the first instruction count is less than the second instruction count; and whether the first instruction count equals the second instruction count.

Example 12 includes the self-checking pair of any of Examples 9-11, wherein the first system on chip synchronizes the first instruction count with the second instruction count by performing at least one of: directing the first single step execution utility to incrementally step through the first plurality of instructions until the first instruction count equals the second instruction count; and pausing execution of the first plurality of application instructions until the first instruction count equals the second instruction count; and wherein the second system on chip synchronizes the first instruction count with the second instruction count by performing at least one of: directing the second single step execution utility to incrementally step through the second plurality of instructions until the second instruction count equals the first instruction count; and pausing execution of the second plurality of application instructions until the second instruction count equals the first instruction count.

Example 13 includes the self-checking pair of any of Examples 9-12, wherein the first system on chip synchronizes the first instruction count with the second instruction count at at least one of: a context switch between execution of different applications; and at the end of a periodic time interval; and at the end of a variable time interval.

Example 14 includes the self-checking pair of any of Examples 9-13, wherein the first system on chip comprises at least one first dynamic memory unit, and the second system on chip comprises at least one second dynamic memory unit, wherein both the at least one first dynamic memory unit and the at least one second dynamic memory unit are periodically refreshed as directed by the respective execution of the first plurality of instructions and the second plurality of instructions.

Example 15 includes the self-checking pair of any of Examples 9-14, wherein the first system on chip is configured to pause execution of the first plurality of application instructions and the second system on chip is configured to pause execution of the plurality of application instructions upon reception of an input/output access until the input/output access is completed on both the first system on chip and the second system on chip.

Example 16 includes the self-checking pair of any of Examples 9-15, wherein the first instruction count is stored in a first performance counter on the first system on chip and the second instruction count is stored in a second performance counter on the second system on chip, wherein both the first performance counter and the second performance counter are registers that are readable by external systems.

Example 17 includes the self-checking pair of any of Examples 9-16, wherein the first plurality of instructions and the second plurality of instructions are assembly instructions.

Example 18 includes a method for synchronizing a self-checking pair of system on chips, the method comprising: executing a first set of application instructions on a first system on chip; executing a second set of application instructions on a second system on chip; providing a first instruction count from the first system on chip to the second system on chip, wherein the first instruction count identifies a number of instructions executed by the first system on chip; providing a second instruction count from the second system on chip to the first system on chip, wherein the second instruction count identifies a number of instructions executed by the second system on chip; comparing the first instruction count to the second instruction count; determining whether to execute a first single step execution utility on the first system on chip or a second single step execution utility on the second system on chip based on the comparison of the first instruction count to the second instruction count; synchronizing the first system on chip to the second system on chip such that the first instruction count equals the second instruction count.

Example 19 includes the method of Example 18, wherein comparing the first instruction count to the second instruction count comprises at least one of: determining that the second instruction count is less than the first instruction count; determining that the first instruction count is less than the second instruction count; and determining that the first instruction count equals the second instruction count.

Example 20 includes the method of any of Examples 18-19, further comprising synchronously refreshing dynamic memory on the first system on chip and the second system on chip, wherein refreshing dynamic memory comprises refreshing as instructed by the respective execution of the first set of application instructions and the second set of application instructions.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A method for using a system on chip, the method comprising:
storing a plurality of instructions, single step execution utility instructions, and a performance counter, wherein the performance counter stores a first instruction count, wherein the first instruction count identifies the number of instructions executed by the system on chip;
executing the plurality of instructions;
communicating with external systems through the at least one communication interface;
receiving a second instruction count from a second system on chip through a communication interface of the at least one communication interface;
comparing the second instruction count to the first instruction count; and
executing the single step execution utility instructions to synchronize the second instruction count with the first instruction count based on the comparison of the second instruction count to the first instruction count.

2. The method of claim 1, wherein comparing the second instruction count to the first instruction count determines at least one of:
whether the second instruction count is behind the first instruction count;
whether the first instruction count is behind the second instruction count; and
whether the first instruction count equals the second instruction count.

3. The method of claim 1, wherein executing the single step execution utility instructions comprises at least one of:
stepping through individual instructions in the plurality of instructions until the first instruction count equals the second instruction count; and
pausing execution of the plurality of application instructions until the first instruction count equals the second instruction count.

4. The method of claim 1, wherein the second instruction count is compared to the first instruction count at at least one of:
a context switch between execution of different applications; and
at the end of a variable time interval;
at the end of a periodic time interval.

5. The method of claim 1, further comprising refreshing at least one dynamic memory unit as directed by at least one instruction in the plurality of instructions.

6. The method of claim 1, further comprising:
pausing execution of the plurality of instructions upon the reception of an input/output access;
recommencing execution of the plurality of instructions upon the completion of the input/output access on both the system on chip and the second system on chip.

7. The method of claim 1, wherein the system on chip and the second system on chip operate in different clock domains.

8. The method of claim 1, wherein the performance counter is a register that is readable by an external system.

9. A self-checking pair of system on chips, the self-checking pair comprising:
a first system on chip configured to execute a first plurality of instructions;
a second system on chip configured to execute a second plurality of instructions, wherein the second plurality of instructions and the first plurality of instructions are approximately identical;
wherein the first system on chip exchanges a first instruction count with the second system on chip, the first instruction count identifying a number of instructions executed by the first system on chip;
wherein the second system on chip exchanges a second instruction count with the first system on chip, the second instruction count identifying a number of instructions executed by the second system on chip;
wherein the first system on chip executes a first single step execution utility to synchronize the first instruction count with the second instruction count and the second system on chip executes a second single step execution utility to synchronize the first instruction count with the second instruction count.

10. The self-checking pair of claim 9, wherein the first system on chip compares the first instruction count against the second instruction count to determine whether to execute the first single step execution utility; and
the second system on chip compares the first instruction count against the second instruction count to determine whether to execute the second single step execution utility.

11. The self-checking pair of claim 10, wherein each of the first system on chip and the second system on chip are configured to compare the first instruction count to the second instruction count to determine at least one of
whether the second instruction count is less than the first instruction count;
whether the first instruction count is less than the second instruction count; and
whether the first instruction count equals the second instruction count.

12. The self-checking pair of claim 9, wherein the first system on chip synchronizes the first instruction count with the second instruction count by performing at least one of:
directing the first single step execution utility to incrementally step through the first plurality of instructions until the first instruction count equals the second instruction count; and
pausing execution of the first plurality of application instructions until the first instruction count equals the second instruction count; and
wherein the second system on chip synchronizes the first instruction count with the second instruction count by performing at least one of:
directing the second single step execution utility to incrementally step through the second plurality of instructions until the second instruction count equals the first instruction count; and
pausing execution of the second plurality of application instructions until the second instruction count equals the first instruction count.

13. The self-checking pair of claim 9, wherein the first system on chip synchronizes the first instruction count with the second instruction count at at least one of:
a context switch between execution of different applications; and
at the end of a periodic time interval; and
at the end of a variable time interval.

14. The self-checking pair of claim 9, wherein the first system on chip comprises at least one first dynamic memory unit, and the second system on chip comprises at least one second dynamic memory unit, wherein both the at least one first dynamic memory unit and the at least one second dynamic memory unit are periodically refreshed as directed by the respective execution of the first plurality of instructions and the second plurality of instructions.

15. The self-checking pair of claim 9, wherein the first system on chip is configured to pause execution of the first plurality of application instructions and the second system on chip is configured to pause execution of the plurality of application instructions upon reception of an input/output access until the input/output access is completed on both the first system on chip and the second system on chip.

16. The self-checking pair of claim 9, wherein the first instruction count is stored in a first performance counter on the first system on chip and the second instruction count is stored in a second performance counter on the second system on chip, wherein both the first performance counter and the second performance counter are registers that are readable by external systems.

17. The self-checking pair of claim 9, wherein the first plurality of instructions and the second plurality of instructions are assembly instructions.

18. A method for synchronizing a self-checking pair of system on chips, the method comprising:
executing a first set of application instructions on a first system on chip;
executing a second set of application instructions on a second system on chip;
providing a first instruction count from the first system on chip to the second system on chip, wherein the first instruction count identifies a number of instructions executed by the first system on chip;
providing a second instruction count from the second system on chip to the first system on chip, wherein the second instruction count identifies a number of instructions executed by the second system on chip;
comparing the first instruction count to the second instruction count;
determining whether to execute a first single step execution utility on the first system on chip or a second single step execution utility on the second system on chip based on the comparison of the first instruction count to the second instruction count;
synchronizing the first system on chip to the second system on chip such that the first instruction count equals the second instruction count.

19. The method of claim 18, wherein comparing the first instruction count to the second instruction count comprises at least one of:
determining that the second instruction count is less than the first instruction count;
determining that the first instruction count is less than the second instruction count; and
determining that the first instruction count equals the second instruction count.

20. The method of claim 18, further comprising synchronously refreshing dynamic memory on the first system on chip and the second system on chip, wherein refreshing dynamic memory comprises refreshing as instructed by the respective execution of the first set of application instructions and the second set of application instructions.
